(19) United States
(12) Patent Application Publication
(10) Pub. No.: US 2008/0178843 A1
(43) Pub. Date: Jul. 31, 2008

(54) Combustion balancing in a homogeneous charge compression ignition engine

(76) Inventors: Kevin P. Duffy, Metamora, IL (US); Andrew J. Kieser, Morton, IL (US); David Schuh, Peoria, IL (US); Michael P. Liechty, Chillicothe, IL (US); William L. Hardy, Peoria, IL (US); Anthony Rodman, Chillicothe, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/657,940

(22) Filed: Jan. 25, 2007

(51) Int. Cl. F02D 41/04

(52) U.S. Cl. 123/435; 123/295

(57) ABSTRACT

A multi cylinder homogeneous charge compression ignition engine includes actuators and an engine controller configured to reduce variations in combustion phasing and/or combustion energy release among the different engine cylinders. By sensing both the phasing and magnitude of the combustion energy release, the engine controller generates control signals to combustion phase controllers and combustion energy release controllers for the engine cylinders. The control signals may be different from one another to reduce variations across the group of engine cylinders. A combustion energy release controller may be a direct injection fuel injector, and the combustion phase controller may be a variable intake valve actuator. Reducing variations in these aspects of the combustion events, allows the engine to operate at higher speeds and loads.

This invention was made with Government support under DOE Contract No. DE-FC26-05NT4 2412 awarded by the U.S. Department of Energy. The Government has certain rights to this invention.

### TECHNICAL FIELD

This disclosure relates generally to homogeneous charge compression ignition (HCCI) engines, and more particularly to balancing at least one of combustion phase timing and combustion energy release among combustion chambers.

### BACKGROUND

A relatively new combustion strategy known as homogeneous charge compression ignition shows great promise in reducing undesirable emissions from internal combustion engines that utilize a compression ignition strategy. HCCI refers generally to the idea of mixing fuel with air in the engine cylinder before autoignition conditions arise. The mixture is compressed to autoignition, with a general desirability that the combustion event take place in the vicinity of top dead center. Although HCCI has proven the ability to drastically reduce undesirable emissions, especially NOx, the combustion strategy has brought new problems that must be overcome in order to render such an engine commercially viable. For instance, for an HCCI engine to be a viable alternative to a counterpart diesel engine, it must have the ability to operate effectively over a relatively wide load range. One problem encountered with HCCI engines is the extreme sensitivity and difficulty in controlling ignition timing. In addition, HCCI engines can have difficulty in operating in higher load ranges where more fuel is supplied to the individual cylinder. This perceived limitation may be due to extreme pressure spikes that occur when the charge burns. The pressures can get so high as to exceed the structural containment capability of an engine housing. Thus, controlling an HCCI engine, especially at higher speeds and loads, can be extremely problematic, but must be overcome to enable such an engine to be a viable alternative to a counterpart diesel engine.

Apart from those problems identified in the previous paragraph, multi-cylinder HCCI engines have even more problems that need to be overcome. For instance, engine geometry, including the intake geometry, fuel injector performance variations, and other known and unknown influences affect the specific burn behavior of charges in different ones of a plurality of engine cylinders. For instance, intake manifold geometry may result in one cylinder receiving less or more air than other cylinders, and a fuel injector performance variation in another cylinder may cause less or more fuel to be injected based upon the same control signal. These differences result in different air fuel ratios in different cylinders. Homogeneous charge combustion is very sensitive to air fuel ratio and other factors. Thus, these variations can contribute to substantial differences in both energy release and combustion phase timing among a plurality of different engine cylinders. While some variation may be more acceptable at lower load conditions, at higher speeds and loads, combustion phasing and energy release variation among the plurality of cylinders can give rise to unacceptable noise levels. In addition, the cylinder with the most advanced combustion will develop a maximum pressure at a lower load, and therefore will limit peak load of the entire engine. Those skilled in the art will appreciate that, when the charge burns too early in the combustion stroke, excessive cylinder pressures can occur that limit the load carrying capability of that cylinder, and hence the entire engine.

One strategy for dealing with the problems of HCCI is described in co-owned U.S. Pat. No. 6,725,838. This reference describes a mixed mode strategy where HCCI is employed over a lower load range portion of the engine, and conventional diesel engine strategies are employed at high speeds and loads. By conventional, this disclosure means that fuel is injected directly into an engine cylinder after autoignition conditions have arisen, with the injection taking place in the vicinity of top dead center. While a mixed mode strategy can produce superior emissions compared to that of a conventional diesel engine, it requires increased complexity, especially in manufacturing and controlling the fuel system, but mixed mode still results in more undesirable emissions than that possible with an entirely HCCI operation strategy.

The present disclosure is directed toward one or more of the problems set forth above.

### SUMMARY OF THE INVENTION

In one aspect, a method of operating an engine includes injecting liquid fuel into a combustion chamber of the engine. A mixture of the fuel and air are compressed in the combustion chamber to an auto ignition condition of the fuel. The injecting and compressing steps are performed in a plurality of different combustion chambers of the engine. Independent adjustments are made in combustion phasing and combustion energy release for different combustion chambers via respective phase and energy release controllers associated with each combustion chamber.

In another aspect, an engine includes an engine housing having a plurality of combustion chambers disposed therein. A plurality of combustion energy release controllers are associated with respected ones of the plurality of combustion chambers. A plurality of combustion phase timing controllers are associated with respective ones of the plurality of combustion chambers. An engine controller is configured to compress mixtures of fuel and air in the combustion chambers to an auto ignition condition of the fuel. The engine controller is also configured to make independent adjustments in combustion phasing and combustion energy release for different combustion chambers via different control signals communicated to the combustion phase timing controllers and combustion energy release controllers, respectively.

### BRIEF DESCRIPTION OF THE DRAWINGS

FIG. 1 is a schematic illustration of a homogeneous charge compression ignition engine according to one aspect of the present disclosure;

FIG. 2 is a second embodiment of an engine schematic according to the present disclosure;

FIG. 3 is a schematic view of an individual combustion chamber for the engine of FIGS. 1 and 2; and

FIGS. 4a-4d are graphs of heat release verses engine crank angle for the engine of FIG. 1 or 2 before any trimming, with fuel trims, with intake valve trims and with both fuel and intake valve trims, respectively.

### DETAILED DESCRIPTION

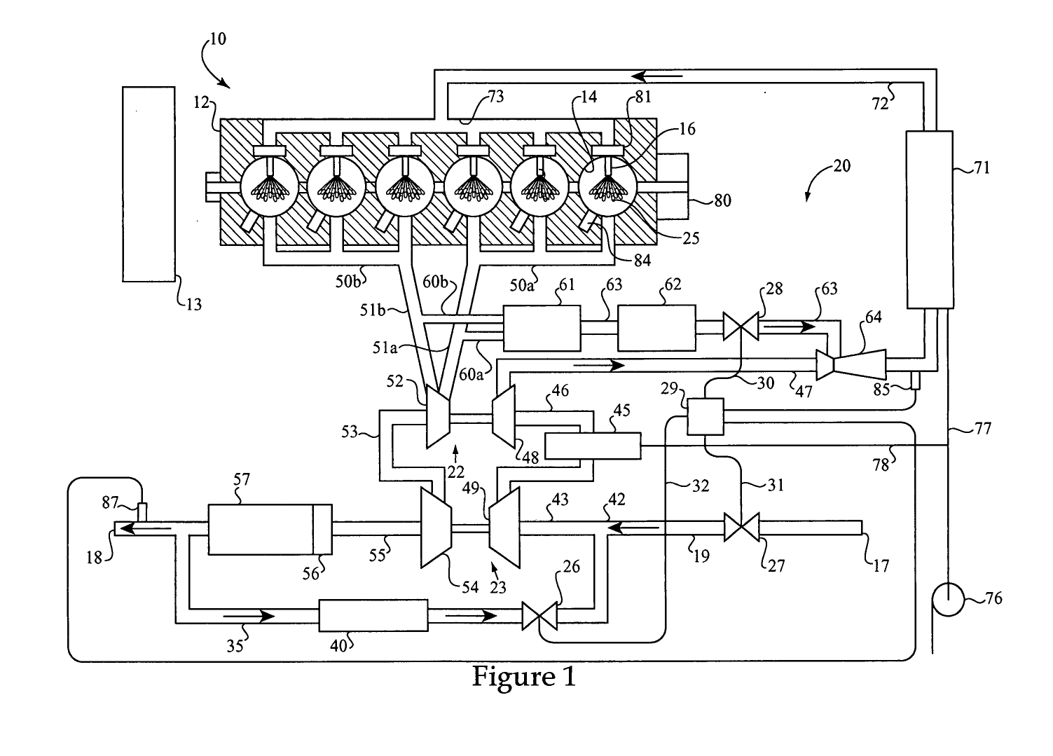

Referring to FIG. 1, a homogeneous charge compression ignition engine 10 includes an engine housing 12 that includes a plurality of cylinders or combustion chambers 14 disposed therein. In the illustrated embodiment, engine 10 includes six cylinders 14, but those skilled in the art will appreciate that engine 10 could include any number of cylinders without departing from the present disclosure. Engine 10 includes a conventional radiator 13 along with a cooling system (not shown) to cool the engine in a conventional manner. Each cylinder 14 preferably includes a fuel injector 16 positioned for direct injection of liquid fuel into the individual cylinders. Furthermore, each fuel injector may include a nozzle tip configured to produce a shower head spray pattern 25 in which fuel injection plumes point at a plurality of different angles with respect to a fuel injector centerline. Furthermore, the fuel injection holes may be constructed using known laser drilling techniques to achieve extremely small diameter openings, which may be on the order of 80-100 microns. Those skilled in the art will appreciate that the small holed shower head spray pattern can facilitate better fuel and air mixing, and possibly permit lower injection pressures without wetting the walls of cylinder 14, which could produce undesirable unburnt hydrocarbon emissions and/or particulate matter.

Engine 10 may also be equipped with a variable geometric compression ratio control device 80 that allows for the compression ratio of all cylinders 14 to be adjusted simultaneously. Although the variable geometric compression ratio control device 80 could take on a variety of forms, it may have a structure similar to that described in co-owned published United States Patent Application 2006/0112911. In that disclosure, an eccentric crank variable compression ratio mechanism raises and/or lowers the crankshaft in the engine housing to alter the compression ratio of all of the cylinders uniformly. Nevertheless, those skilled in the art will appreciate that any appropriate strategy for varying compression ratio may be considered appropriate for an engine 10 according to the present disclosure. Those skilled in the art will appreciate that having the ability to vary compression ratio can render the problem of combustion control timing and the problem associated with extremely high pressures during combustion more manageable than with a fixed compression ratio engine.

Engine 10 may also be constructed to include variable intake valve actuators 81 as an alternative, or in addition to, the variable geometric compression ratio device 80. Those skilled in the art will appreciate that the variable intake valve actuator can also take on a variety of forms, such as purely electronically controlled, or a hybrid that uses cam actuation and a special hydraulic actuator to hold the intake valve open beyond a cam dictated valve closing timing. The later alternative is described, for instance, in co-owned published U.S. Patent Application 2003/0116124. This variable timing capability can also be exploited to adjust compression ratio in the individual cylinders by adjusting the timing at which the intake valve closes. In addition, variable valve timing affects combustion phasing by adjusting the charge mass in the cylinder, apart from compression ratio. Engine 10 may also be equipped with variable exhaust valves (not shown) as an alternative, or in addition to the variable intake valve actuators 81. Unlike the variable geometric compression ratio device 80, each individual cylinder includes an individually controllable variable intake valve actuator 81, which allows the behavior of each cylinder 14 to be individually controlled. Preferably, engine 10 is equipped with both a variable geometric compression ratio device 80 and variable intake valve actuators 81 that allow en banc adjustments of all cylinders 14 via the variable geometric compression ratio device 80, and then finer and faster control of combustion phasing in individual cylinders 14 via the variable intake valve actuators 81.

Engine 10 may also be equipped with some means for detecting the timing of combustion events in each individual cylinder 14 so that that information can be fed back to a combustion controller, which may then use that information to adjust combustion timing for a subsequent event. In the illustrated embodiment, an individual combustion pressure sensor or an ion sensor 84 is associated with each of the individual cylinders 14. Nevertheless, those skilled in the art will appreciate that any single or multiple sensor strategy that permits the timing of combustion events in each of the cylinders 14 to be determined in real time would be suitable for engine 10 of the present disclosure, and may be desirable to better enable closed loop combustion timing control.

Engine 10 also includes a fresh air inlet 17, a tail pipe 18 and an exhaust gas recirculation system 20. A combination of fresh air and exhaust gas are supplied to engine intake manifold 73 via an engine intake passage 72, which is separated from an air/exhaust gas passage 70 by an air-to-air after cooler 71. Those skilled in the art will appreciate that cooler 71 may include measures, such as being made at least partially from stainless steel, to resist the corrosive influences of exhaust gas passing therethrough. In addition, cooler 71 may include any suitable heat exchanger, including liquid to gas, etc. Exhaust from the individual cylinders 14 collect in first and second exhaust manifolds 50a and 50b, which are respectively connected to exhaust passages 51a and 51b. Nevertheless, those skilled in the art will appreciate that a single exhaust manifold and exhaust passage could be utilized without departing from the scope of the present disclosure. The exhaust passages 51a and 51b feed into a turbine 52 of a turbocharger 22 in a conventional manner. However, a portion of the exhaust that would otherwise go to turbine 52 is instead routed into branch recirculation passages 60a and 60b, which merge in the vicinity of a coated diesel particulate filter 61. Those skilled in the art will appreciate that particulate filter 61 may be coated with any suitable catalyst for any desired purpose, such as to clean the high pressure exhaust being recirculated via these passages. In addition, those skilled in the art will appreciate that particulate filter 61 is preferably positioned in close enough proximity to cylinders 14 that it can be regenerated via heat supplied by the engine. Alternatively, a separate auxiliary regeneration device, which produces its own heat, may be positioned in close proximity to particulate filter 61 to facilitate its regeneration. After passing through particulate filter 61, the high pressure exhaust passes through a clean gas intake cooler 62 and a control valve 28 before connecting to the throat of a venturi 64, which empties into air/exhaust gas return passage 70. Control valve 28 may take on a variety of forms, but may be a relatively simple two-position valve that is never fully closed. For instance, the flow area through control valve 28 in its first position may be chosen to facilitate a desired exhaust gas recirculation level associated with low load or idle positions, and a second or more fully open position may be associated with higher speeds and loads to facilitate higher volumes of exhaust gas recirculation. Nevertheless, control valve 28 may have more than two positions, and may even include a fully closed position, if desired. Control valve 28 is controlled by an electronic control module 29 via a communication line 30 in a conventional manner.

Medium pressure exhaust gas leaves an axial passage from turbine 52 into an inter turbine passage 53, which connects to a turbine 54 of a second turbocharger 23 which is in series with turbocharger 22. Turbine 54 may be an axial turbine, and its lower pressure axial outlet empties into turbine outlet 55. Before arriving at tail pipe 18, the relatively low pressure exhaust is passed through a coated diesel particulate filter 57, which may include any suitable catalyst to treat the exhaust prior to exiting tail pipe 18. Because particulate filter 57 may be relatively remote from the heat of the individual cylinders 14, an auxiliary regeneration device 56 may be included in order to provide the heat necessary to regenerate particulate filter 57. After exiting particulate filter 57, a portion, which may be all of the exhaust gas, exits at tail pipe 18. However, a portion of that low pressure exhaust may be recirculated via low pressure exhaust passage 35. The low pressure exhaust gas is cooled in a clean gas intake cooler 40 prior to encountering a control valve 26. Control valve 26 may have a plurality of discrete positions, or may have a complete continuum of positions from a fully closed to a fully opened position, depending upon the desired action and sophistication of the exhaust gas recirculation system 20. Control valve 26 may be controlled by electronic control module 29 via communication line 32.

Fresh air entering fresh air inlet 17 passes through a throttle control valve 27 prior to entry into a fresh air supply passage 19, which merges with low pressure exhaust passage 35 at a tee connection 42. Throttle control valve 27 is controlled in its positioning by electronic control module 29 via a communication line 31. Those skilled in the art will appreciate that throttle control valve 27 may have a continuum of positions ranging from a restricted fully throttled position that still allows some fresh air to enter the system, to an unrestricted fully open position. The mixture of low pressure exhaust gas and fresh air is supplied to compressor 49 of turbocharger 23 via compressor supply passage 43. Those skilled in the art will appreciate that compressor 49 may include measures, such as use of corrosion resistant titanium, to deal with the corrosive influence, if any, existing in the exhaust gas passing through the compressor. An inter compressor passage 46 connects compressor 49 to compressor 48 of turbocharger 22. An inter cooler 45 may be included in inter compressor passage 46 to cool the compressed exhaust/air mixture. In addition, cooler 45 may include corrosion resistant materials, such as stainless steel, to avoid or reduce the corrosion influences, if any, of the exhaust gas. Like compressor 49, compressor 48 may include corrosive resistant materials such as titanium, to reduce or avoid corrosive influences from the exhaust gas.

A air/exhaust mixture passage 47 fluidly connects the outlet of compressor 48 to the inlet of venturi 64. Thus, venturi 64 represents the mixing location for exhaust from the high pressure side of the exhaust gas recirculation system 20 with low pressure exhaust that originated near the tail pipe, but has had its pressure boosted as a result of passing through compressors 48 and 49.

If desired, coolers 45 and 71 may be connected to a condensate pump 76 via respective condensate passages 78 and 77, to facilitate removal of collected condensed water and other liquids in coolers 45 and 71 in a conventional manner. Although not necessary, engine 10 may also include one or more NOx/lambda sensors 85 and 87 at specific locations in order to allow for gas constituent levels to be monitored during operation of engine 10. In particular, the lambda sensors 85 and 87 may monitor the contents of several different gases in air/exhaust gas return passage 70, and this information may be used to further facilitate combustion control of combustion events in the individual cylinders 14.

Although engine 10 is illustrated as including staged turbochargers 22 and 23, those skilled in the art will appreciate that the engine could include a single turbocharger without departing from the scope of the present disclosure. In such a case, the high pressure exhaust return could connect upstream from the turbocharger, whereas the low pressure exhaust gas return would connect downstream from the same. Those skilled in the art will appreciate that the relative proportions of exhaust gas to fresh air are controlled by electronic control module 29 by appropriately positioning control valves 26, 27 and 28. When the relatively high proportions of EGR are demanded, such as on the order of 50% or more, electronic control module 29 throttles control valve 27 to restrict the supply of fresh air, and moves valves 26 and 28 towards there fully opened positions to enable the higher ratios of exhaust gas recirculation associated with desired operating conditions at higher speeds and loads for engine 10.

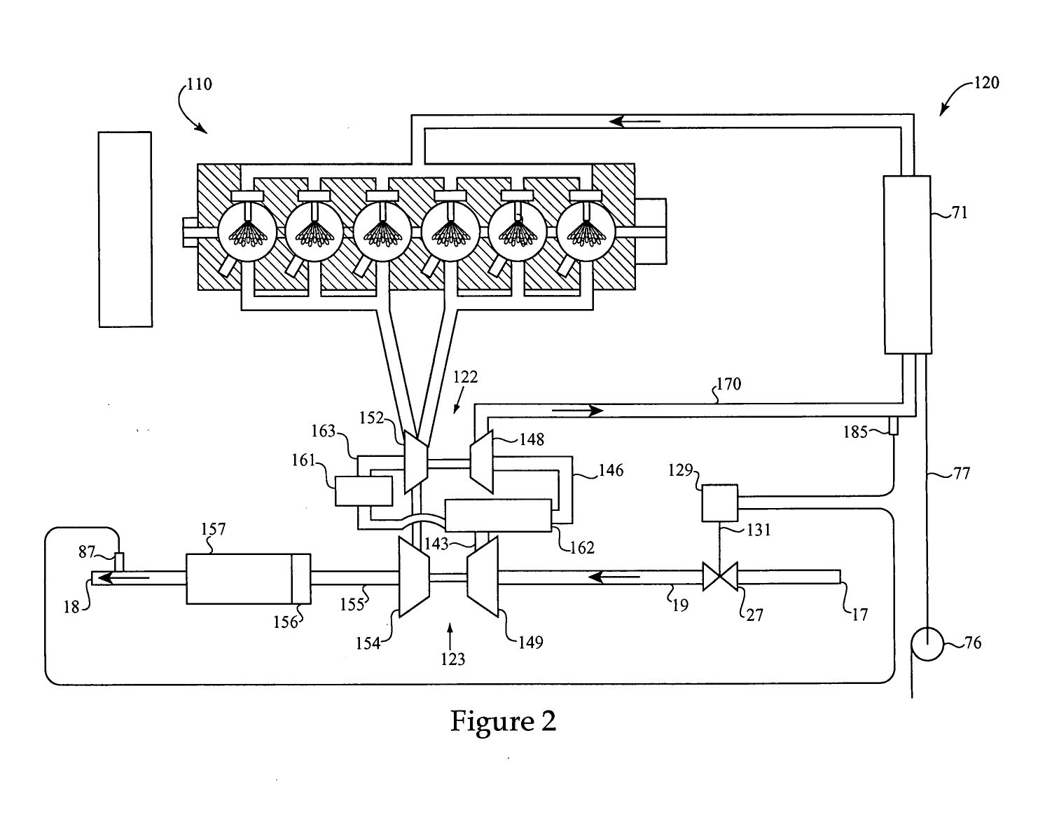

Referring now to FIG. 2, a homogeneous charge compression ignition engine 110 is shown with many features that are identical to engine 10 described earlier. However, the exhaust gas recirculation system 120 includes several differences relative to the exhaust gas recirculation system 20 described in relation to engine 10. In particular, while exhaust gas recirculation system 120 includes a pair of staged turbochargers 122 and 123 in series, there is only a single medium pressure exhaust gas recirculation 163 rather than the separate high and low pressure exhaust gas return passages associated with engine 10. In exhaust gas recirculation passage 120, the exhaust gas is supplied to turbine 152 of turbocharger 122 and the medium pressure exhaust gas exits turbine 152 via an axial passage connected to medium pressure exhaust gas recirculation passage 163, and via a separate inter turbine passage 153 that connects to turbine 154 of turbocharger 123. The low pressure exhaust then exits turbine 154, which may be an axial turbine, and empties into turbine outlet 155 before passing through a coated diesel particulate filter 157. As in the previous embodiment, the particulate filter 157 may include any suitable catalyst coating and may include any auxiliary regeneration device 156 that generates the heat necessary to regenerate particulate filter 157. After traversing particulate filter 157, the exhaust gas passes a NOx/lambda sensor 187 on its way out of the tail pipe 18.

The medium pressure exhaust exiting turbine 152 into medium pressure exhaust recirculation passage 163 passes through a coated diesel particulate filter 161 and then enters a clean gas intake inter cooler 162. Meanwhile, fresh air enters at fresh air intake 17 and passes through a throttle control valve 27 into a fresh air supply passage 19. The fresh air is then compressed in compressor 149 of turbocharger 123 before entering air supply passage 143, which merges with medium pressure exhaust gas recirculation passage 163 in cooler 162. Cooler 162 empties into an inter compressor passage 146 that connects to compressor 148 of turbocharger 122. Compressor 148 may include corrosion resistant materials, such as titanium, to better resist any corrosive influence, if any from the exhaust gas being recirculated. The compressed mixture of exhaust gas and fresh air leaves turbocharger 148 and enters exhaust gas recirculation passage 170, where it passes a lambda sensor 185 on its way to the engine intake passage via an air to air after cooler similar to that described with regard to the previous embodiment. As in the previous embodiment, throttle control valve 27 is controlled via electronic control module 129 via a communication line 131. Thus, the exhaust gas recirculation system 120 of the embodiment of FIG. 2 is simplified over that of the embodiment of FIG. 1 in that the ratios of exhaust gas to fresh air is controlled entirely by appropriately positioning throttle control valve 27, rather than by utilizing three valves as in the previous embodiment.

Those skilled in the art will appreciate that HCCI operation is very sensitive to air/fuel ratio charge mass and compression ratio. As a consequence, a slight difference in any one of the air/fuel ratio charge mass or compression ratio between two different cylinders can result in substantial differences in both combustion phase timing and combustion heat release. Small variations in air fuel ratio and/or charge mass can have a variety of sources. For instance, geometry of the air intake manifold as well as the position of the individual cylinder with respect to that manifold can affect small differences among different cylinders in the amount of air (and exhaust from EGR) that reaches that individual cylinder. In addition, less than thoroughly mixed exhaust gas with fresh air can also alter conditions in a specific cylinder. Another possible source of variation in air/fuel ratio and/or charge mass can be attributed to performance variations among different fuel injectors. For instance, the same control signal delivered to a plurality of different fuel injectors will inherently result in slightly different amounts of fuel being injected by the different fuel injectors. Better or worse spray atomization may also contribute to variations in individual cylinder performance. In any event, without any adjustments among the plurality of engine cylinders 14, there will be variations in combustion phase timing and combustion heat release. Although not readily apparent, the cylinder with the most advanced combustion phase timing can limit the overall load range of the entire engine. As load increases, this early firing cylinder will eventually cause pressure rise rates and pressure maximum limits in that individual cylinder to be exceeded before that of the others. In addition, variations in combustion phase timing and combustion heat release can also lead to ever increasing amounts of noise as engine load increases. Thus, those skilled in the art will recognize that inherent variations among different engine cylinders 14 will otherwise limit the load range of the entire engine unless some measure is taken to balance or reduce variations in combustion phase timing and/or combustion heat release among the engine cylinders.

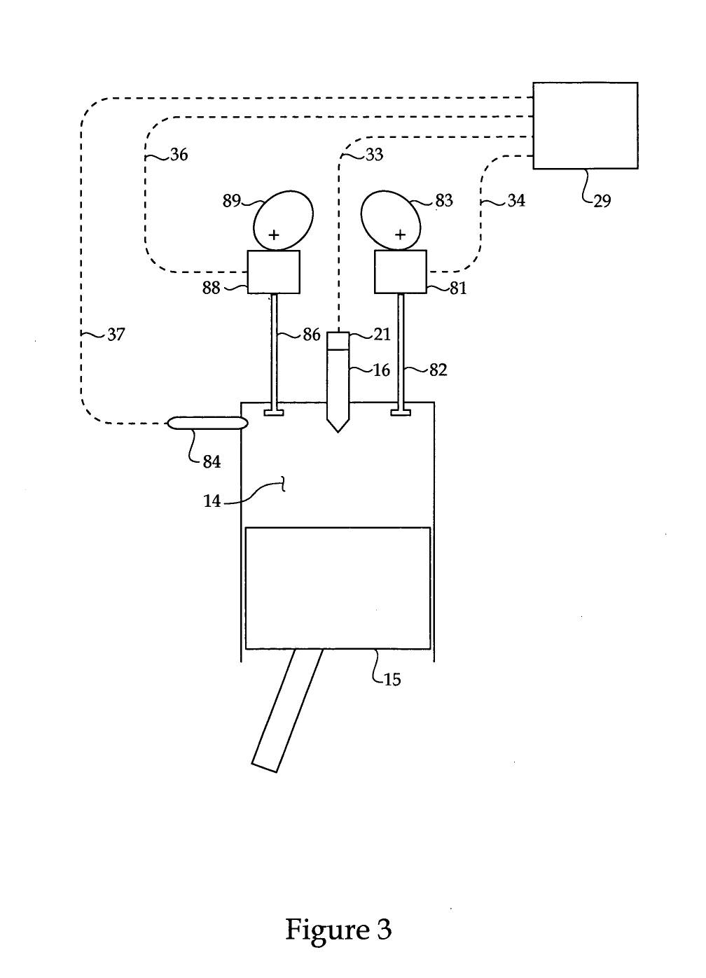

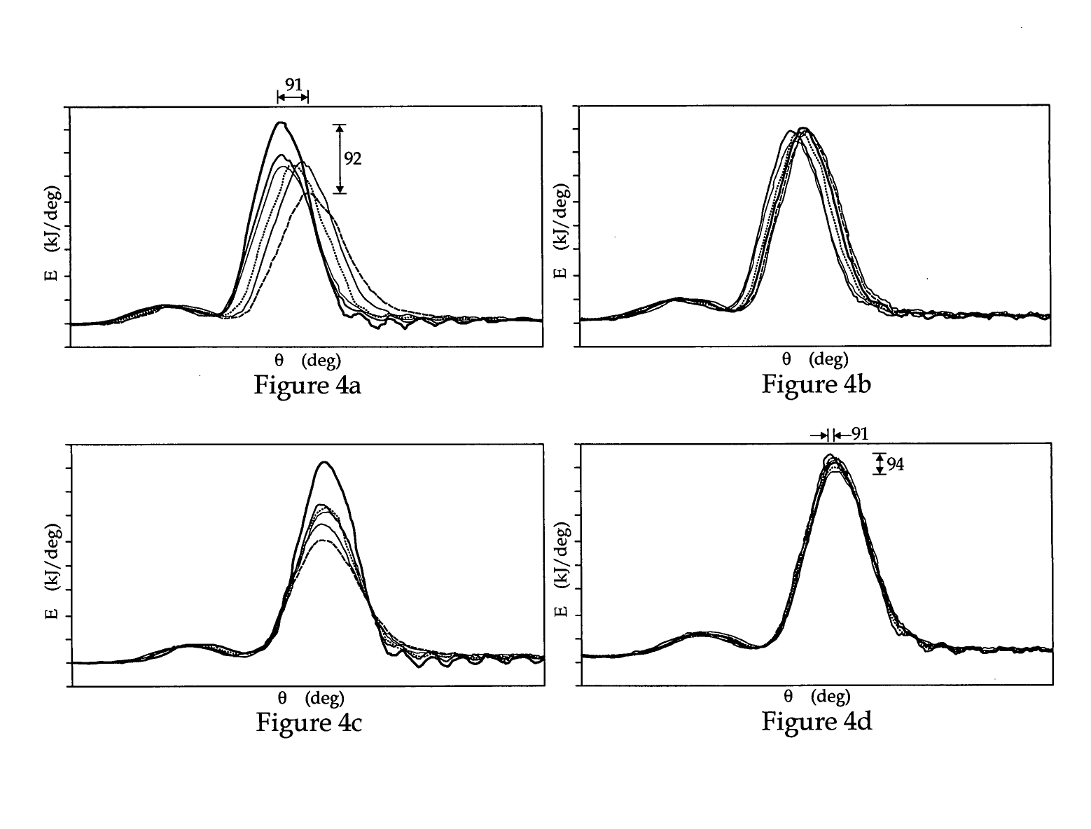

Referring now to FIGS. 3 and 4a-d, a typical engine cylinder 14 for the engines 10 and 110 of FIGS. 1 and 2 is illustrated. Cylinder 14 includes a reciprocating piston 15 and an electronically controlled fuel injector 16 positioned for injection of liquid fuel directly into cylinder 14. Fuel injector 16 includes an electrical actuator 21 operable to control fuel injection quantity from fuel injector 16 via control signals transmitted from engine controller 29 via communication line 33. The engine controller is configured to make independent adjustments in fuel injection quantity to individual cylinders 14 via different control signals communicated to different fuel injectors 16 associated with the different cylinders 14. As used in the present disclosure, fuel injectors 16 can be thought of as combustion heat release controllers. In other words, by adjusting individual signals to individual fuel injectors 16, the fuel injectors can be adjusted in their fuel injection quantity to result in less variation in combustion heat release among all of the engine cylinders 14. For instance, a cylinder with a higher than average combustion heat release may have its variation reduced by altering its control signal to slightly reduce the quantity of fuel that the fuel injector 16 for that individual cylinder 14 injects. Those skilled in the art will appreciate that engine controller 29 may be configured to have a closed loop control strategy for continuously adjusting combustion heat release whenever the engine 10, 110 is in operation. Nevertheless, those skilled in the art will appreciate that the present disclosure also contemplates a non-closed loop strategy where the individual control signal adjustments to the various cylinders are preset, and may be updated on some periodic bases, such as at each engine startup or during routine servicing intervals.

In closed loop operation, the engine controller 29 determines a combustion heat release for combustion in the different engine cylinders 14 in one engine cycle, and then determines which of the engine cylinders are in need of having there combustion heat release adjusted to reduce variation. If a cylinder is in need of adjustment, the engine controller 29 will determine a fuel injector control signal adjustment that will either increase or decrease the combustion heat release for that individual cylinder. In the illustrated embodiment, determination of combustion heat release is accomplished by individual combustion sensors 84 associated with each individual cylinder 14 that communicate information to engine controller 29 via communication lines 37. In the illustrated embodiment, combustion sensor 84 is a pressure sensor, but those skilled in the art will appreciate that other sensors such as ion sensors or any suitable strategy known in the art that can be utilized to estimate combustion heat release for an individual cylinder could be utilized. In the present disclosure, each individual cylinder 14 includes its own combustion sensor 84. However, the present disclosure also contemplates strategies where each individual cylinder includes more than one sensor to determine combustion characteristics, or a strategy that includes a number of sensors less than the number of engine cylinders, but still able to determine individual combustion characteristics sufficient to carry out the control strategy of the present disclosure. Depending upon the desired sophistication and possibly the speed of engine controller 29, combustion heat release can be estimated in a number of ways. A general equation for the apparent heat release rate may be expressed as

$$\frac{d Q}{d t} = \frac{r}{r - 1} P \frac{d V}{d t} + \frac{1}{r - 1} V \frac{d p}{d t}$$

where:
r=ratio of specific heats
P=pressure at time t
V=instantaneous chamber volume
   For instance, a simple numerical integration strategy could be utilized on the entire equation over the combustion duration. Alternatively, an adequate estimation of combustion energy release can be obtained with less intensive processing by recognizing that the dv/dt term in the equation may be ignored if HCCI combustion occurs near top dead center. Those skilled in the art recognize that because combustion chamber volume changes very little in the brief time it takes for the charge to burn around TDC. In one insightful alternative, even numerical integration can be avoided by recognizing that the maximum dQ/dt in the above equation correlates directly to the total Q or heat release. Thus, if one cylinder shows a maximum dQ/dt that is high, the control signal to that fuel injector would be shortened to decrease the quantity of fuel in order to decrease the maximum dQ/dt and hence the total heat release. Likewise, if the maximum dQ/dt for an individual cylinder is low, the control signal to the fuel injector for that signal would be lengthened to increase the quantity of fuel, increase the maximum dQ/dt and hence bring the total heat release for that cylinder into balance with the other cylinders. Thus, any level of sophistication can be applied to estimate combustion heat release provided that strategy allows engine controller 29 to determine variation among the cylinders in combustion energy release with sufficient accuracy to adjust control signals to the individual fuel injectors 16 accordingly. Thus, in closed loop operation, the variation among the individual cylinders in combustion energy release can be decreased to a point that the variation is acceptable. This aspect of the disclosure is illustrated in FIGS. 4a and 4b. The combustion energy release variation 92 shown in FIG. 4a before any control signal adjustments can be compared with the relatively smaller variation 94 shown in FIG. 4b after the fuel injector control signals for the individual cylinders 16 have been adjusted. Those skilled in the art will appreciate that the fuel injector control signals can be adjusted toward an average of the cylinders or toward some predetermined combustion energy release for that specific operating condition of engine 10, 110.

Apart from reducing variations among the individual cylinders in combustion energy release, engines 10 and 110 may also include a means for individually adjusting combustion phase timing in the individual cylinders 14. Thus, the present disclosure contemplates individual combustion phase controllers associated with each of the individual cylinders 14. In the illustrated embodiment, these combustion phase controllers take the form of variable intake valve actuators 81 that allow for the intake valve 82 to be held open beyond a cam dictated closing timing determined by the lobe position of cam 83. Combustion phase controlling may also be controlled by a variable exhaust valve actuator 88 associated with exhaust valve 86 and cam 89. Although the present disclosure illustrates variable valve timing via valve actuators that work in conjunction with cams 83 and 89, those skilled in the art will appreciate that either the intake and/or exhaust may be totally electronically controlled, such as via hydraulic actuators of the type known in the art. In the illustrated embodiment, the variable intake valve actuators 81 are controlled by engine controller 29 via communication lines 34, and variable exhaust valve actuators 88 are controlled via communication lines 36. Thus, by adjusting individual control signals to one or both of the variable valve actuators 81 and 88, the amount of gas received in that cylinder 14 can be adjusted to adjust the charge mass. This in turn adjusts the air fuel ratio as well as the pressure and temperature at TDC in that individual cylinder 16, and hence the combustion phase timing in that cylinder. In addition, combustion phasing is controlled by compression ratios which is determined by the ratio of cylinder volume when the valve(s) close to cylinder volume at top dead center.

Combustion phase timing can be based upon any suitable combustion characteristic, such as maximum dp/dt or maximum pressure. The illustrated embodiment identifies combustion phase timing at the inflection point of the pressure versus time trace reflected by maximum dp/dt. Thus, the same combustion sensor 84 may be utilized to determine combustion phase timing for an individual cylinder 14 by determining the timing at which the peak cylinder pressure rise rate occurs. This information can then be utilized, and a comparison between all of the engine cylinders can be performed, and variation among the cylinders can be reduced by adjusting individual variable valve actuators 81 and/or 88 for that cylinder in a subsequent engine cycle. Nevertheless, those skilled in the art will appreciate that a separate different sensor could be utilized for determining combustion phase timing determination apart from the pressure sensor 84 illustrated. In the event that combustion phase timing is adjusted using only the variable intake valve actuator 81, closing the intake valve 82 later in an engine cycle will reduce charge mass and compression ratio, which will retard combustion phase timing. On the other hand, closing the intake valve 82 earlier in the engine cycle will increase charge mass and compression ratio which will advance combustion phase timing. FIGS. 4a and 4c are useful in illustrating this concept. In the case of FIG. 4a, the combustion phase timing variation 91 is relatively large, but after the individual cylinders have been trimmed by adjusting individual control signals to the respective variable intake valve actuators 81, the variance is reduced as shown in FIG. 4c to a small phase timing variation 93. FIG. 4d is of interest for showing the combustion heat release traces after both the combustion phase timing and combustion heat release magnitude variations have been reduced.

### INDUSTRIAL APPLICABILITY

Those skilled in the art will recognize that, unlike conventional diesel engines, homogenous charge compression ignition engines may require substantially larger amounts of EGR in order to better facilitate operation across a broad range of speeds and loads of the engine. In fact, these EGR rates may exceed 50% of the gas being supplied to the intake of the engine. These extremely high levels of exhaust gas recirculation are typically not available in exhaust gas recirculation systems associated with conventional diesel engines. Thus, when engines 10 and 110 are operating in the highest portions of there load ranges, increased proportions of exhaust gas are supplied in the recirculation systems 20, 120 by throttling the fresh air intake valves 27 in order to promote the higher EGR levels. In the case of engine 10 at lower speeds and loads, throttle control valve 27 may be positioned in a fully opened condition, whereas the relative proportions of desired EGR are maintained by appropriately positioning control valves 26 and 28 associated with the low and high pressure exhaust gas passages, respectively. On the other hand, the engine of 110 controls the relative proportions of exhaust gas to fresh air by adjusting the position of throttle control valve 27 across the engines operating range.

Those skilled in the art will appreciate that exhaust gas can be useful in manipulating both ignition timing and the maximum pressure of a combustion event in a homogenous charge compression ignition engine. Because the chemical constituents of the exhaust typically are of higher heat capacity than those of pure air, increasing the percentage of inducted exhaust gas can serve as a heat sink to absorb combustion energy that might otherwise result in an extreme pressure spike. Thus, elevated levels of exhaust gas can reduce peak cylinder pressure and cylinder pressure rise rates, by slowing the combustion rate and retard ignition timing, which will allow for operation at ever higher loads. With all other things being equal, an increased percentage of inducted exhaust in the cylinder will also allow for an increased compression ratio for a given combustion phasing and vice versa. Thus, increased amounts of EGR can be used to retard ignition timing, whereas reduced EGR rates can be utilized to advance ignition timing. Thus, varying amounts of exhaust gas recirculation coupled with a variable compression ratio device and/or the variable intake valve actuator can provide three useful control levers for adjusting ignition timing and maximum cylinder pressure across a wide range of operating conditions.

Those skilled in the art will also appreciate that some attention should be paid to balancing the desire to boost intake pressure by extracting energy from the exhaust gases via turbocharger(s), verses routing exhaust gas for recirculation prior to extracting all of the potential energy therefrom. This issue is addressed in the engines 10 and 110 by including staged turbochargers 122 and 123 in series with one another. However, the present disclosure contemplates a single turbocharger for the engine or possibly two or more turbochargers in series and/or parallel with an appropriate arrangement that allows for sufficient intake boost pressure while allowing for increased exhaust gas recirculation rates associated with homogeneous charge compression ignition operation at higher speeds and loads. Those skilled in the art will appreciate that all of the strategies disclosed above for varying cylinder pressures and cylinder pressure rise rates are closely coupled. Thus, one might wish to rely largely on the variable compression ratio device for bulk changes in compression ratio, rely upon varying amounts of EGR to adjust ignition timing, and may rely upon variable intake valve actuator for quick adjustments from cycle to cycle and to adjust for differences among the cylinders in their behavior. Nevertheless, the control inputs can be mixed and utilized as desired to achieve a desired response time and arrive at a new operating condition with sufficient control capabilities available to operate the engine in any desired fashion.

In order to extend the operating range of engine 10, 110 into higher load ranges, it may be necessary to reduce variations among the engine cylinders 14 in at least one of combustion phase timing and combustion energy release. Those skilled in the art will appreciate that the maximum load capability for an engine occurs when at least one of the engine cylinders produces a peak cylinder pressure or pressure rise rate at or above some predetermined threshold associated with the containment capabilities of the engine housing (e.g., engine block and engine head, etc.). By adjusting combustion phase timing, the variation among the individual cylinders 14 can be reduced and the load range extended since all of the cylinders will approach the peak cylinder pressure limit or pressure rise rate limit more in unison rather than one early firing cylinder reaching its limit at a lower load condition. The load range of engine 10, 110 is also extended by adjusting control signals to individual fuel injectors 16 to reduce variations among the engine cylinders with respect to combustion energy release. Thus, if one cylinder has a higher than average combustion energy release, its control signal would be shortened toward a direction of injecting slightly less fuel, whereas a cylinder with a low combustion energy release would have its fuel injector control signal extended to inject slightly more fuel. By power balancing the cylinders, the sound emissions from the engine can be reduced, especially at higher loads, and the entire engine can be operated at higher loads than that realistically practical or possible with unbalanced cylinders.

In the illustrated embodiment, the maximum load range capability of the engine is maintained throughout its operation by operating the combustion phase timing variation reduction strategy and the combustion energy release variation strategy in a closed loop fashion in the background of the engine operation control. Thus, one could expect the control signals to the fuel injectors 16 and variable intake valve actuators 18, 81 to the individual cylinders 14 to constantly be adjusted to compensate for variations in the combustion phase timing and combustion energy release among the engine cylinders due to inherent factors associated with the engine, and other factors. For instance, inherent variations in the fuel injectors can be compensated for as well as variations resulting from intake manifold geometry. However, by continuously operating the variation reduction algorithm in the background, other sources of variation in combustion phase timing and combustion energy release, such as fresh air pressure, fresh air temperature, engine temperature, EGR temperature and the like can also be compensated for.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

1. A method of operating an engine, comprising the steps of:
compressing a mixture of the fuel and air in the combustion chamber to an autoignition condition of the fuel;
performing compressing steps in a plurality of different combustion chambers of the engine;
making independent adjustments in combustion phasing for different combustion chambers via individual phase controllers; and
making independent adjustments in combustion energy release via individual combustion energy release controllers, which are different from the phase controllers.

2. The method of claim 1 including a step of determining a combustion phase timing in each of the different combustion chambers; and
the making independent adjustments in combustion phasing step includes adjusting the individual phase controllers associated with each of the different combustion chambers based upon the determined combustion phase timings.

3. The method of claim 2 wherein the individual phase controllers include gas exchange valves for each of the combustion chambers;
the determining step includes sensing combustion with a sensor for each combustion chamber; and
the adjusting step includes setting closing timings of the gas exchange valves based upon the respective determined combustion phase timings.

4. The method of claim 3 wherein the individual phase controllers include variable intake valve actuators associated with each of the different combustion chambers;
the sensing step includes sensing pressure in each combustion chamber during a combustion event; and
the adjusting step includes closing an intake valve at an earlier engine angle to advance a combustion phase timing, and closing the intake valve at a later engine angle to retard a combustion phase timing.

5. The method of claim 1 including a step of determining a combustion energy release for each of the different cylinders;
estimating a combustion energy release for each combustion chamber; and
the making independent adjustments in combustion energy release step includes adjusting the individual combustion energy release controllers associated with each of the different cylinders based upon the determined combustion energy releases.

6. The method of claim 5 wherein the individual combustion energy release controllers include fuel injectors for each of the combustion chambers;
the estimated combustion energy release is based upon a maximum sensed combustion pressure rise rate in each combustion chamber; and
the adjusting step includes adjusting fuel injection quantities based upon the determined combustion energy releases.

7. The method of claim 6 wherein the adjusting step includes shortening a fuel injector control signal to decrease a combustion energy release, and lengthening a fuel injector control signal to increase a combustion energy release.

8. The method of claim 7 including a step of determining a combustion phase timing in each of the different combustion chambers; and
the making independent adjustments in combustion phasing step includes adjusting the individual phase controllers associated with each of the different combustion chambers based upon the determined combustion phase timings.

9. The method of claim 8 wherein the individual phase controllers include gas exchange valves for each of the combustion chambers; and
the phase adjusting step includes setting closing timings of the gas exchange valves based upon the respective determined combustion phase timings.

10. The method of claim 9 wherein the individual phase controllers include variable intake valve actuators associated with each of the different combustion chambers; and
the phase adjusting step includes closing an intake valve at an earlier engine angle to advance a combustion phase timing, and closing the intake valve at a later engine angle to retard a combustion phase timing.

11. The method of claim 1 wherein the second making step includes reducing a variance in combustion energy release among the different combustion chambers.

12. The method of claim 1 wherein the first making step includes reducing a variance in combustion phase timing among the different combustion chambers.

13. The method of claim 12 wherein the second making step includes reducing a variance in combustion energy release among the different combustion chambers.

14. An engine comprising:
an engine housing having a plurality of combustion chambers disposed therein;
a plurality of combustion energy release controllers for respective ones of the plurality of combustion chambers;
a plurality of combustion phase timing controllers for respective ones of the plurality of combustion chambers; and
an engine controller configured to compress mixtures of fuel and air in the combustion chambers to an autoignition condition of the fuel, and configured to make independent adjustments in combustion phasing and combustion energy release for different combustion chambers via different control signals communicated to the combustion phase timing controllers and the combustion energy release controllers, respectively.

15. The engine of claim 14 wherein the combustion energy release controllers include a fuel injector positioned for direct injection of liquid fuel into each of the combustion chambers.

16. The engine of claim 15 wherein each fuel injector includes an electronic quantity control actuator in control communication with the engine controller; and
a combustion sensor positioned for sensing combustion in each of the combustion chambers and being in communication with the engine controller.

17. The engine of claim 14 wherein the combustion phase timing controllers include variable timing gas exchange valves for each of the combustion chambers.

18. The engine of claim 17 wherein the variable timing gas exchange valves include variable intake valve actuators in control communication with the engine controller.

19. The engine of claim 18 wherein the combustion energy release controllers include a fuel injector positioned for direct injection of liquid fuel into each of the combustion chambers;
each fuel injector includes an electronic quantity control actuator in control communication with the engine controller; and
a pressure sensor positioned to sense pressure in each of the combustion chambers and being in communication with the engine controller.

20. The engine of claim 14 wherein the engine controller is configured to reduce variances in combustion phase timing and combustion energy release among the combustion chambers via the different control signals.
